(19) United States
(12) Patent Application Publication
(10) Pub. No.: US 2013/0248043 A1
(43) Pub. Date: Sep. 26, 2013

(54) STRUCTURAL TUBE COMPRISING A FIBRE REINFORCED POLYMER

(71) Applicants: Romesh Aluwihare, London (GB); James George Arthur Croll, London (GB)

(72) Inventors: Romesh Aluwihare, London (GB); James George Arthur Croll, London (GB)

(73) Assignee: SYNCROMESH SYSTEMS LIMITED, London (GB)

(21) Appl. No.: 13/825,097

(22) PCT Filed: Sep. 20, 2011
(86) PCT No.: PCT/GB2011/051769

§ 371 Date: Jun. 3, 2013

(30) Foreign Application Priority Data
Sep. 20, 2010 (GB) 1015680.0

(51) Int. Cl. F16L 9/12

(52) U.S. Cl. CPC F16L 9/121; F16L 9/123
USPC 138/144; 138/153

(57) ABSTRACT

There is provided a structural tube (1) comprising a fibre reinforced polymer wherein the tube comprises a plurality of layers (21, 22, 23, 24, 25) of reinforcing fibres with the fibres of at least one layer having a different orientation to those of another layer. Also provided is a kit of structural tubes and a structural tube assembly.

### FIELD OF INVENTION

The present invention relates to structural tubes, particularly though not exclusively to scaffold tubes, and to structures comprising structural tubes and to tube kits.

### BACKGROUND TO THE INVENTION

Structural tubes are known for a number of applications one of the more common being as scaffold tubes. Tubes used in for example tube and fit scaffold systems are extensively employed for the construction and repair of buildings and other infrastructure. Current tube and fit scaffold systems use metallic tubes. The design and erection of metallic tube scaffold systems benefits from the experience of decades of successful use. However, the use of metal scaffold tubes presents problems. As a result of their high density they are heavy to transport, and awkward to handle during erection and dismantling. Their high thermal capacity means they can be very uncomfortable to handle when operating at high or low temperatures. Furthermore, in certain environments they suffer high rates of corrosion rendering them unfit for purpose, sometimes after quite short periods of use.

Accordingly, the present invention aims to address at least one disadvantage associated with the prior art whether discussed herein or otherwise.

### SUMMARY OF INVENTION

According to a first aspect of the present invention there is provided a structural tube comprising a fibre reinforced polymer wherein the tube comprises a plurality of layers of reinforcing fibres with the fibres of at least one layer having a different orientation to those of another layer.

Suitably, there is provided a fibre reinforced polymer structural tube wherein the tube comprises a plurality of layers of reinforcing fibres with the fibres of at least one layer having a different orientation to those of another layer.

Suitably, there is provided a structural tube comprising a fibre reinforced polymer wherein the tube wall comprises a plurality of layers of reinforcing fibres with the fibres of each layer having a different orientation to those of at least one of the other layers.

Suitably, the tube comprises hoop wound fibres. Suitably, the tube comprises helically wound fibres. Suitably, the tube comprises fibres orientated in a helical form about the axis of the tube. Suitably, the tube comprises a layer of hoop wound fibres. Suitably, the tube comprises a layer of helically wound fibres. Suitably, the tube comprises a layer of fibres orientated in a helical form about the axis of the tube.

Suitably, the tube comprises longitudinally extending fibres. Suitably, the tube comprises longitudinal fibres. Suitably, the tube comprises axially extending fibres. Suitably, the tube comprises axial fibres. Suitably, the tube comprises a layer of fibres arranged to extend substantially parallel to the axis of the tube. Suitably, the tube comprises layers of fibres arranged to extend substantially parallel to the axis of the tube. Suitably, the tube comprises a layer of longitudinally extending fibres. Suitably, the tube comprises layers of longitudinally extending fibres. Suitably, the tube comprises a layer of longitudinal fibres. Suitably, the tube comprises layers of longitudinal fibres. Suitably, the tube comprises a layer of axially extending fibres. Suitably, the tube comprises layers of axially extending fibres. Suitably, the tube comprises a layer of axial fibres. Suitably, the tube comprises layers of axial fibres. Suitably, the tube comprises a layer of fibres arranged to extend substantially parallel to the axis of the tube. Suitably, the tube comprises layers of fibres arranged to extend substantially parallel to the axis of the tube.

Suitably, the tube is a scaffold tube.

Suitably, the tube comprises a hollow cylinder. Suitably, the tube comprises a hollow cylinder having circular cross section.

Suitably the tube has an outer diameter D of between 45 mm and 55 mm, suitably of between 47 and 50 mm, for example around 48.3 mm. Suitably the tube has a wall thickness T of between 2 mm and 6 mm, suitably of between 3 mm and 5 mm, for example around 4 mm. Suitably, the tube has an internal diameter of between 35 mm and 45 mm, suitably of between 39 mm and 42 mm, for example around 40.30 mm. The tube may have an internal diameter of around 39.5 mm

Suitably, the tube comprises one or more polymers. Suitably, the tube comprises a polymer resin. The tube may comprise two or more polymers reinforced with fibres. Suitably, the tube comprises a polymeric matrix. Suitably, the tube comprises a polymeric resin. Suitably, the tube comprises one or more polymers binding fibres together. Suitably, the tube comprises a polymeric matrix binding fibres together. Suitably, the tube comprises a polymeric resin binding fibres together. Suitably, the tube comprises a fibre reinforced polymer in which the polymer forms a polymeric matrix binding fibres together.

Suitably, the tube comprises polyester polymer. Suitably, the tube comprises a polyester resin. Suitably, the polymer comprises a polymeric resin. Suitably, the tube comprises a vinylester resin. Suitably, the tube comprises polyurethane. Suitably the tube comprises a polyurethane resin.

Suitably, the tube is coloured. Suitably, the polymer is coloured with colour pigments. The colouration may be provided by colour pigments which may be added to the polymeric resin. The colour may be used to provide an indication of the strength grade of the tube.

Suitably, the reinforcing fibres comprise one or more of: glass fibres; aramid fibres; boron fibres; natural fibres or carbon fibres. For example the fibres may comprise e-glass or s-glass fibres.

Suitably, the tube comprises three or more layers of fibres. Suitably, the tube comprises four or more layers of fibres. Suitably, the tube comprises five or more layers of fibres. Suitably, the tube comprises five layers of fibres.

Suitably, the tube comprises substantially concentric layers of fibres. Suitably, the tube comprises concentric layers of fibres. Suitably, the tube comprises three or more concentric layers of fibres. Suitably, the tube comprises four or more concentric layers of fibres. Suitably, the tube comprises five or more concentric layers of fibres. Suitably, the tube comprises five concentric layers of fibres.

Suitably, each fibre layer comprises fibres and a polymer binding the fibres together. Suitably, each fibre layer comprises fibres and a polymeric matrix binding the fibres together. Suitably, each fibre layer comprises fibres and a polymeric resin binding the fibres together.

Suitably, the tube comprises a polymeric matrix binding the fibre layers together. Suitably, the tube comprises a polymer binding the fibre layers together. Suitably, the tube comprises a polymeric resin binding the fibre layers together.

Suitably, the tube comprises a single polymeric matrix bonding all the fibres. The tube may comprise a single polymer bonding all the fibres.

Suitably, the tube comprises one or more layers of helically wound fibres. Suitably the tube comprises two or more layers of helically wound fibres, for example two layers.

Suitably, the tube comprises one or more layers of longitudinally extending fibres. Suitably the tube comprises two or more layers of longitudinally extending fibres. Suitably the tube comprises three or more layers of longitudinally extending fibres, for example three layers.

Suitably, the tube comprises two layers of helically wound fibres interposed by one or more layers of longitudinally extending fibres and/or one or more substantially fibre free layers of polymeric matrix. Suitably, the tube comprises two layers of helically wound fibres interposed by a layer of longitudinally extending fibres.

Suitably, the tube is such that the majority of the longitudinally extending fibres lie in a layer between two layers of helically wound fibres.

Suitably, the tube is such that two layers of hoop wound fibres are spaced apart by a distance of at least 0.5 mm, suitably at least 1.0 mm. The tube may be such that two layers of hoop wound fibres are spaced apart by a distance of at least 1.5 mm, for example at least 1.8 mm.

Suitably, the tube is such that two layers of hoop wound fibres are spaced apart by one or more layers of longitudinally extending fibres by a distance of at least 0.5 mm, suitably at least 1.0 mm. The tube may be such that two layers of hoop wound fibres are spaced apart by one or more layers of longitudinally extending fibres by a distance of at least 1.5 mm, for example at least 1.8 mm. The layer of longitudinal fibres spacing the hoop wound fibres may have a thickness of around 2.0 mm.

Suitably, the tube is such that a substantial proportion of longitudinally extending fibres of the tube are located between two layers of helically wound fibres. Suitably, the tube is such that a layer of longitudinal fibres located between two layers of helically wound fibres comprises a greater proportion (by volume) of longitudinal fibres than any other layer.

Suitably, at least 30% by volume of the longitudinally extending fibres of the tube are located between two layers of helically wound fibres. Suitably, at least 40% by volume of the longitudinally extending fibres of the tube are located between two layers of helically wound fibres, for example at least 45% by volume of the longitudinally extending fibres of the tube may be located between two layers of helically wound fibres. Around 50% by volume of the longitudinally extending fibres of the tube may be located between two layers of helically wound fibres.

The tube may be such that the majority of longitudinally extending fibres of the tube are located between two layers of helically wound fibres. Suitably, at least 50% by volume of the longitudinally extending fibres of the tube are located between two layers of helically wound fibres. Suitably, at least 60% by volume of the longitudinally extending fibres of the tube are located between two layers of helically wound fibres, for example at least 70% by volume of the longitudinally extending fibres of the tube may be located between two layers of helically wound fibres.

Surprisingly it has been found that concentrating the longitudinally extending fibres between the helically wound layers rather than near the outer surface of the tube may provide a tube with enhanced hoop strength whilst also providing good axial stiffness. Surprisingly it has been found that optimising the separation of two layers of helically wound fibres may enhance the hoop strength of the tube such that the volume fraction of helically wound fibres in the tube may be reduced which may thus allow an increase in the volume fraction of longitudinally extending fibres which in turn may allow the tube to have increased bending and axial stiffness.

Suitably, the tube comprises two layers of longitudinally extending fibres interposed by one or more layers of helically wound fibres and/or one or more layers of longitudinally extending fibres and/or one or more substantially fibre free layers of polymeric matrix.

Suitably, the tube comprises two layers of longitudinally extending fibres interposed by two layers of helically wound fibres which in turn are interposed by a layer of longitudinally extending fibres.

Suitably, the tube comprises an external protective layer. Suitably, the external protective layer comprises a layer of woven fibre fabric within a polymeric matrix.

Suitably, the tube comprises concentric layers with the following composition from outermost to innermost layer:

(i) protective layer
(ii) longitudinally extending fibre layer;
(iii) helically wound fibre layer;
(iv) longitudinal extending fibre layer;
(v) helically wound fibre layer;
(vi) longitudinally extending fibre layer.

Suitably, the tube comprises two layers of helically wound fibres which are separated by a distance t3.

Suitably, the tube comprises two layers of helically wound fibres having respective thicknesses t2 and t4 and which are interposed by a layer of longitudinal extending fibres having thickness t3. Suitably, t3 is greater than t2. Suitably, t3 is greater than t4. Suitably t3 is at least 5 times greater than t2 or t4. t3 may for example be at least 8 times greater than t2 or t4. Suitably t3 is at least 10 times greater than t2 or t4. t3 may for example be at least 12 times greater than t2 or t4,

Suitably, the tube comprises layers (iii) and (v) of helically wound fibres having thickness t2 and t4 respectively and which are separated by a distance t3.

Suitably, t3 is at least 2 times greater than t2, for example t3 may be at least: 3 times; 4 times; 5 times; 6 times; 7 times; 8 times; 9 times; 10 times or 11 times greater than t2. Suitably, t3 is no more than 17 times greater than t2, for example no more than: 16 times; 15 times; 14 times; 13 times or 12 times; or 11 times greater than t2. t3 may be around 10 times greater than t2.

Suitably, t3 is at least 2 times greater than t4, for example t3 may be at least: 3 times; 4 times; 5 times; 6 times; 7 times; 8 times; 9 times; 10 times or 11 times greater than t4. Suitably, t3 is no more than 17 times greater than t4, for example no more than: 16 times; 15 times; 14 times; 13 times; 12 times; or 11 times greater than t4. t3 may be around 10 times greater than t4.

Suitably, t2 is no more than twice the size of t4 and no less than half the size of t4. Suitably, t2 is between 0.5 and 1.5 times the size of t4. Suitably, t2 is between 0.9 and 1.1 times the size of t4. For example, t2 and t4 may be substantially the same.

Suitably, the tube comprises two layers of longitudinally extending fibres having respective thicknesses t1 and t5. Suitably, t1 is no more than twice the size of t5 and no less than half the size of t5. Suitably, t1 is between 0.5 and 1.5 times the size of t5. Suitably, t1 is between 0.9 and 1.1 times the size of t5. For example, t1 and t5 may be substantially the same.

Suitably, the tube comprises layers (ii) and (vi) of longitudinally extending fibres having thickness t1 and t5 respectively.

Suitably, each of t1 and t5 are no more than five times the size of t2 or t4 and no less than a fifth of the size of t2 or t4. Suitably, each of t1 and t5 are no more than three times the size of t2 or t4 and no less than a third of the size of t2 or t4.

Suitably, t1 is between 0.5 and 5.0 times the size of t2. Suitably, t1 is between 2 and 5 times the size of t2, for example around 3 to 4 times the size of t2. Suitably, t1 is between 0.5 and 5 times the size of t4. Suitably, t1 is between 2 and 5 times the size of t4, for example around 3 to 4 times the size of t4.

Suitably, t5 is between 0.5 and 5.0 times the size of t2. Suitably, t5 is between 2 and 5 times the size of t2, for example around 3 to 4 times the size of t2. Suitably, t5 is between 0.5 and 5.0 times the size of t4. Suitably, t5 is between 2 and 5 times the size of t4, for example around 3 to 4 times the size of t4.

Suitably, the layers having thickness t1 and t5 are interposed by layers having thicknesses t2, t3 and t4. Suitably, the layers having thickness t2 and t4 are interposed by the layer having thickness t3.

Suitably, t3 is at least 2 times greater than t1, for example t3 may be at least: 3 times; 4 times; or 5 times greater than t1. Suitably, t3 is no more than 10 times greater than t1, for example no more than: 9 times; 8 times; 7 times; or 6 times greater than t1.

Suitably, t3 is at least 2 times greater than t5, for example t3 may be at least: 3 times; 4 times; 5 times; 6 times; or 7 times greater than t5. Suitably, t3 is no more than 12 times greater than t5, for example no more than: 11 times; 10 times; 9 times; or 8 times greater than t5.

Suitably the tube comprises a protective layer having a thickness of t0. The protective layer may also be referred to as a veil.

Suitably, t0 has a thickness of between 0.05 mm and 0.3 mm, suitably between 0.15 mm and 0.25 mm, for example around 0.20 mm.

Suitably, t1 has a thickness of between 0.2 mm and 1.0 mm, suitably between 0.5 mm and 0.9 mm, suitably between 0.6 mm and 0.9 mm, suitably between 0.6 mm and 0.8 mm, for example around 0.63 mm.

Suitably, t2 has a thickness of between 0.1 mm and 0.6 mm, suitably between 0.1 mm and 0.4 mm, suitably between 0.2 mm and 0.4 mm, suitably between 0.2 mm and 0.3 mm, for example around 0.20 mm.

Suitably, t3 has a thickness of between 1.5 mm and 3.0 mm, suitably between 2.0 mm and 2.6 mm, suitably between 2.0 mm and 2.4 mm, for example around 2.35 mm.

Suitably, t4 has a thickness of between 0.1 mm and 0.6 mm, suitably between 0.1 mm and 0.4 mm, suitably between 0.2 mm and 0.4 mm, suitably between 0.2 mm and 0.3 mm, for example around 0.20 mm.

Suitably, t5 has a thickness of between 0.2 mm and 1.0 mm, suitably between 0.6 mm and 1.0 mm, suitably between 0.6 mm and 0.9 mm, suitably between 0.8 mm and 1.0 mm, for example around 0.82 mm.

Suitably, the tube comprises layers having the following composition:

(i) protective layer;
(ii) longitudinally extending fibre layer;
(iii) helically wound fibre layer;
(iv) longitudinal extending fibre layer;
(v) helically wound fibre layer;
(vi) longitudinally extending fibre layer;

The tube may comprise layers having the following composition:

(i) protective layer, thickness t0 about 0.20 mm;
(ii) longitudinally extending fibre layer thickness t1 about 0.49 mm;
(iii) helically wound fibre layer thickness t2 about 0.30 mm;
(iv) longitudinal extending fibre layer thickness t3 about 2.34 mm;
(v) helically wound fibre layer thickness t4 about 0.29 mm;
(vi) longitudinally extending fibre layer thickness t5 about 0.38 mm;

The tube may comprise layers having the following composition:

(i) protective layer, thickness t0 about 0.20 mm;
(ii) longitudinally extending fibre layer thickness t1 about 0.63 mm;
(iii) helically wound fibre layer thickness t2 about 0.2 mm;
(iv) longitudinal extending fibre layer thickness t3 about 2.35 mm;
(v) helically wound fibre layer thickness t4 about 0.2 mm;
(vi) longitudinally extending fibre layer thickness t5 about 0.82 mm;

Suitably, longitudinal extending fibres are provided in fibre bundles of fibre filaments. Suitably, the longitudinal fibres bundles have numbers of individual fibre filaments measured in terms of weights per meter. The longitudinal fibre bundles may be between 1 g/m and 10 g/m, suitably between 3 g/m and 7 g/m, for example between 4.5 g/m and 5 g/m. The longitudinal fibre bundles may be 1.2 g/m, 2.4 g/m, 4.8 g/m or 9.6 g/m. For example longitudinal extending fibres may be arranged in bundles having 4.8 g/m.

Suitably, each layer of longitudinal extending fibres comprises multiple fibre bundles of fibre filaments. Suitably each layer of longitudinal extending fibres comprises the number of bundles that gives the required layer thickness and fibre weight fractions in each layer. Suitably, each layer of longitudinal extending fibres comprises fibres such that they have a volume fraction of from 50% to 80%, preferably 55% to 70%, for example, around 62%.

Suitably, layer (ii) comprises between 20 and 60 fibre bundles, suitably between 30 and 40 fibre bundles. For example, layer (ii) may comprise 32 number of 4.8 g/m bundles. Layer (ii) may comprise bundles of filament fibres having relative density of 2.55 in polyester matrix having relative density 1.2. With 32 number of 4.8 g/m bundles this may provide layer thickness 0.63 mm and fibre volume fraction of 58%.

Suitably, layer (iv) comprises between 80 and 150 fibre bundles, suitably between 90 and 120 fibre bundles. For example, layer (iv) may comprise 100 number of 4.8 g/m bundles. Layer (iv) may comprise bundles of filament fibres having relative density of 2.55 in polyester matrix having relative density 1.2. With 100 number of 4.8 g/m bundles this may provide layer thickness 2.35 mm and fibre volume fraction of 58%.

Suitably, layer (vi) comprises between 20 and 60 fibre bundles, suitably between 30 and 40 fibre bundles. For example, layer (vi) may comprise 32 number of 4.8 g/m bundles. Layer (vi) may comprise bundles of filament fibres having relative density of 2.55 in polyester matrix having relative density 1.2. With 32 number of 4.8 g/m bundles this may provide layer thickness 0.82 mm and fibre volume fraction of 58%.

Suitably, helically wound fibres are provided in fibre bundles of fibre filaments. Suitably, the helically wound fibre bundles have numbers of individual fibre filaments measured in terms of weights per meter. The helically wound fibre bundles may be between 0.5 g/m and 10 g/m, suitably between 1 g/m and 3 g/m, for example between 1.0 g/m and 1.5 g/m. The helically wound fibre bundles may be 1.2 g/m, 2.4 g/m, 4.8 g/m or 9.6 g/m. For example helically wound fibres may be arranged in bundles having 1.2 g/m.

Each layer of helically wound fibres may be formed using a bobbin delivering one or more bundles of fibre filaments per winding circuit. For example, each layer may be formed using a bobbin delivering a bundle of fibre filaments of around 1.2 g/m wound at a pitch of around 4 mm. The fibre volume fraction may be determined from the number of bundles of fibre filaments per winding circuit, the pitch of the windings and the bundle weight and density.

The term “pitch” may refer to the bobbin pitch (p1) which is the longitudinal distance moved by any one bundle in a complete circuit of the bobbin. Alternatively, the term “pitch” may refer to the longitudinal spacing (p2) between adjacent winding bundles. For a bobbin delivering nb fibre bundles per circuit p1=nb×p2. Thus, where a single fibre bundle is wound at a time p1 and p2 have the same value.

Each layer of helically wound fibres may comprise multiple bundles of fibre filaments for each bobbin winding circuit. Each layer of helically wound fibres may comprise a single bundle of fibre filaments for each bobbin winding circuit. Suitably each layer of helically wound fibres comprises the number of bundles that gives the required layer thickness and fibre volume fractions in each layer. Suitably, each layer of helically wound fibres comprises fibres such that they have a volume fraction of from 40% to 70% for example, around 48%. Suitably, each layer of helically wound fibres comprises fibre bundles such that they have a volume fraction of from 40% to 70%, preferably from 50% to 60%, for example around 56%.

Suitably, layer (iii) comprises between 1 and 10 fibre bundles per bobbin winding circuit. Layer (iii) may be formed by winding a single fibre bundle for each circuit of a bobbin. Alternatively, layer (iii) may be formed by winding a plurality of fibre bundles, for example 1 to 8 fibre bundles, for each circuit of a bobbin.

Suitably, layer (iii) comprises a fibre bundle which recurs every 1 mm to 10 mm (the longitudinal spacing alternatively referred to as pitch p2) over the length of the tube. Suitably, layer (iii) comprises a fibre bundle wound with a longitudinal spacing of between 3 mm and 6 mm. For example, layer (iii) may comprise a 1.2 g/m bundle at every 4 mm of length of tube, alternatively referred to as 4 mm pitch (p2). Layer (iii) may comprise a bundle of filament fibres having relative density of 2.55 in polyester matrix having relative density 1.2. With a 1.2 g/m bundle wound at a pitch of 4 mm this may provide layer thickness 0.20 mm and fibre volume fraction of 56%.

Suitably, layer (v) comprises between 1 and 10 fibre bundles per bobbin winding circuit. Layer (v) may be formed by winding a single fibre bundle for each circuit of a bobbin. Alternatively, layer (v) may be formed by winding a plurality of fibre bundles, for example 1 to 8 fibre bundles, for each circuit of a bobbin.

Suitably, layer (v) comprises a fibre bundle which recurs every 1 mm to 10 mm (the longitudinal spacing alternatively referred to as pitch p2) over the length of the tube. Suitably, layer (v) comprises a fibre bundle wound with a longitudinal spacing of between 3 mm and 6 mm. For example, layer (v) may comprise a 1.2 g/m bundle at every 4 mm of length of tube, alternatively referred to as 4 mm pitch (p2). Layer (v) may comprise a bundle of filament fibres having relative density of 2.55 in polyester matrix having relative density 1.2. With a 1.2 g/m bundle wound at a pitch of 4 mm this may provide layer thickness 0.20 mm and fibre volume fraction of 56%.

The pitch of the helically wound fibres or fibre bundles may be from 10 mm to 30 mm for example around 20 mm. The pitch of the helically wound fibre bundles may be from 10 mm to 30 mm for example around 20 mm when measured as a bobbin pitch (p1) and when the tube comprises two ore more bundles of fibres wound simultaneously. The longitudinal spacing (p2) between one bundle centre and the next along the tube length may for example be between 2 mm and 10 mm when the bobbin pitch (p1) is between 10 mm and 30 mm and when two or more bundles are wound simultaneously.

The pitch of the helically wound fibres or fibre bundles may be from 2 mm to 10 mm for example around 4 mm. The pitch of the helically wound fibre bundles may be from 2 mm to 10 mm for example around 4 mm when measured as a bobbin pitch (p1) and when the fibre bundle is not wound simultaneously with another fibre bundle. The longitudinal spacing (p2) between one bundle centre and the next along the tube length suitably corresponds to the bobbin pitch (p1) when the fibre bundle is not wound simultaneously with another fibre bundle.

The pitch of the helically wound fibres or bundles of fibres may depend on the number of bundles delivered from the bobbin and the distance the bobbin moves along the tube axis for each complete winding circuit. Suitably, a single bundle may be used on each bobbin. Suitably, the bobbin pitch (p1) of the helically wound fibres or fibre bundles is from 2 mm to 10 mm, suitably from 3 mm to 6 mm, suitably from 4 mm to 5 mm, for example around 4 mm.

Suitably, the tube comprises a layer of helically wound fibres or one or more fibre bundles in which the fibres or fibre bundle(s) are wound in a clockwise direction. Suitably, the tube comprises a layer of helically wound fibres or one or more fibre bundles in which the fibres or fibre bundles are wound in an anti-clockwise direction. Suitably, the tube comprises a first layer of helically wound fibres or one or more fibre bundles in which the fibres or fibre bundle(s) are wound in a clockwise direction and a second layer of helically wound fibres or one or more fibre bundles in which the fibres or fibre bundle(s) are wound in an anti-clockwise direction.

Suitably, the longitudinal spacing (pitch p2) of the helically wound fibres or one or more fibre bundles wound in a clockwise direction is from 2 mm to 10 mm, suitably from 3 mm to 6 mm, suitably from 4 mm to 5 mm, for example around 4 mm. Suitably, longitudinal spacing (pitch p2) of the helically wound fibres or one or more fibre bundles wound in an anti-clockwise direction is from 2 mm to 10 mm, suitably from 3 mm to 6 mm, suitably from 4 mm to 5 mm, for example around 4 mm. Suitably, the longitudinal spacing (pitch p2) of the fibres or fibre bundles wound in the clockwise direction is substantially the same as that of those wound in the anti-clockwise direction.

Suitably, the tube is manufactured to have alternating layers of longitudinal extending fibres and helically wound fibres. Suitably, the tube is made by a combination of a pultrusion technique and a form of helical winding. Suitably, the tube is made by a pull-winding technique. Suitably a pull-winding manufacturing process can be used for the manufacturing.

Suitably, the tube is resistant to chemical corrosion. Suitably, the tube has low electrical conductivity. Suitably, the tube has low thermal conductivity.

Suitably, the tube is adapted to be compatible in a scaffold system comprising metallic tubes.

The tube may have an outer diameter equivalent to that of a metallic scaffold tube.

The tube may comprise a fibre reinforced polymeric (frp) advanced composite tube.

The tube may be lighter than a metallic tube having equivalent strength. The tube may for example be about one quarter the weight of the equivalent steel tube.

The tube may be resistant to even quite hostile working environments which may allow its safe use to be extended to periods measured in decades rather than years.

The tube may be suitable for use in a tube and fit scaffold system. The tube may be suitable for use in a modular scaffold system.

The tube may be such that the type of fibre, its volume content, its orientation with respect to the axial direction of the tube and its distribution across the thickness of the tube have all been carefully selected to be compatible with the requirements of structural tubes, of the type used in for example, the scaffold industry.

In structural tubes there is a need to not only produce high overall bending stiffness but also hoop wall bending strength that is capable of withstanding the high local bending associated with, say, the use of standard scaffold couplers. The tube may be such that it meets these requirements.

The tube may comprise a specially designed multi-layered fibre reinforced polymeric (frp) composite tube in which the proportions, distributions and orientations of fibre in each layer have been chosen to provide a tube that has sufficiently high overall bending stiffness and local hoop wall bending strength to provide viable structural components to meet the loading requirements experienced in for example the construction of tube and fit scaffold systems.

The tube may have a low density relative to its strength. This may mean that a scaffold system constructed using such tubes will be overall much lighter than an equivalent steel system allowing considerable advantage for the transport of tubes and their erection and dismantling on site. Furthermore, the reduced weight may have health and safety benefits and reduce the risks of personal injury since operators will be handling lighter weights.

Suitably, the tube has poor electrical conductivity. This may mean means that those working on scaffolds constructed of such tubes will have a reduced risk of electrocution.

Suitably, the tube has low thermal conductivity. This may mean that tubes will be much more pleasant to handle in extremes of temperature.

The tube may be resistant to corrosion. Even in normal urban environments steel tubes are likely to require regular replacement, while in more corrosive offshore environments and in certain industrial applications the likely tube life could be a lot less. The tube may have a longer lifetime than such steel tubes.

The tube may be colour coded to suit a user's needs or to indicate the particular nature of use of the tube. This may allow an operator to readily identify their tubes or a user to indicate for what the tube is being used. The tube may be colour coded to indicate its strength. This may allow an operator to readily know which tubes can be used for different load grades within a scaffold system.

The tube may be constructed from high strength fibre reinforced polymers (frp) having multi-layers of axial and hoop wound fibres, designed to provide high overall tube bending performance and high local hoop bending capacity.

The tube may have a designed overall bending performance. The tube may have a designed overall bending capacity which makes it suitable for applications requiring overall bending rigidity, within for example scaffold structures.

The tube may have a designed local bending capacity of the tube wall which makes it suitable for resisting high localised loading, such as that experienced in the attachment of standard scaffold couplers to allow application within scaffold structures.

The tube may be constructed from high strength fibre reinforced polymers (frp), in which colour pigments within the polymeric resin matrix provide a clear indication of the ownership or the use being made of the tube. The tube may comprise colour pigments within the polymeric resin matrix which assist site safety, corporate awareness and/or public/pedestrian visibility. The tube may be constructed from high strength fibre reinforced polymers (frp), in which colour pigments within the polymeric resin matrix provide a clear indication of the strength grade of the tube.

The tube may be provided with indicator means to indicate the strength of the tube.

The tube may comprise a tube which can be cut into lengths suitable for the construction of for example fabricated tube and fit scaffold systems.

The tube may comprise a composite tube in which the volume fraction of fibre in its multi-layers is adapted to provide a tube with a strength grades suitable for example for tube and fit scaffold systems. A scaffold system may comprise such tubes having various specifications for load capacity and for which the strength grade of each tube to provide this load capacity is clearly defined by the use of colour coded matrix. A scaffold system may comprise such tubes having various specifications for load capacity and for which the strength grade of each tube to provide this load capacity is clearly marked by labelling permanently embedded within the surface veil. The tube may be light to transport and handle during erection and dismantling of for example scaffold systems.

The tube may have an outer diameter adapted to suit its use. The tube may for example have an outer diameter that is compatible with more conventional steel and aluminium scaffold tubes.

The tube may be such that it can be used interchangeably with more conventional steel and aluminium scaffold tubes.

The tube may be such that it is compatible with the use of conventional scaffold ancillary equipment such as jointing clips, couplers, connecting sleeves and spiggots, and support plates.

The tube may be resistant to the corrosive effects of air and water. The tube may consequently be likely to require much less frequent replacement than conventional metallic scaffold tubes.

The tube may be resistant to the effects of chemical and biological attack. The tube may consequently be attractive for use in corrosive marine and industrial environments.

The tube may be an insulator to electricity and may reduce the risk of accidental electrocution for all those working with and on for example the scaffold structure.

The tube may have low specific heat capacity and may consequently be comfortable to handle in extremes of hot and cold weather.

The tube may have a low modulus of elasticity. This may mean that when such tubes impact each other they emit lower frequency sound than equivalent metallic tubes meaning that handling during erection and demolition may be less noisy and environmentally intrusive than for equivalent metallic tubes.

The tube may have a hardened thin outer surface veil to protect the tube from wear and tear.

The tube may be constructed from high strength and stiffness fibres integrally embedded in a polymeric resin.

The tube may be adapted to be cut to lengths suitable for the provision of fabricated tubular frame scaffold systems used for the construction, maintenance, repair and demolition of buildings and other infrastructure.

The tube may be adapted to be used compatibly with more conventional metallic scaffold tubes and ancillary jointing equipment.

The tube may be adapted to form part of a modular scaffold system. The tube may comprise a modular scaffold tube. The tube may comprise an interlocking arrangement which allows the tube to be interlocked with another component, such as for example a ledger, transom or scaffold board, without the need for the use of scaffold clips or couplers.

The tube may be translucent. The tube may be semi translucent. The tube may be adapted such that a light source can be located within the cavity defined by the tube wall and transmit light to the exterior of the tube.

The tube may comprise a light source. The tube may comprise a light source located within the cavity defined by the tube wall.

The tube may comprise a power source. The tube may comprise a photo electric cell. The tube may comprise one or more photo electric cells embedded within the tube wall.

The tube may comprise one or more photo electric cells coupled to one or more light sources and may be adapted to store solar energy during the daytime to power the light source(s) at night time.

The tube may be electromagnetic interference neutral.

According to a second aspect of the present invention there is provided a kit of structural tubes wherein the kit comprises a plurality of tubes according to the first aspect and wherein at least one tube has a first strength grade and is provided with strength indicator means and at least one tube has a second strength grade and is provided with strength indicator means such that tubes of different strength grades can be readily distinguished.

Suitably, the strength indicator means are covered by or embedded in a veil of the tube so that the indicator means is protected from wear. The indicator means may comprise markings and/or colouration.

Suitably, there is provided a kit of structural tubes wherein the kit comprises a plurality of tubes according to the first aspect and wherein at least one tube has a first strength grade and is provided in a first colour and at least one tube has a second strength grade and is provided in a second colour such that tubes of different strength grades can be readily distinguished.

Suitably, the kit comprises tubes of two or more strength grades, for example three strength grades. Suitably, each strength grade of tube has a distinct colour.

The kit may comprise three grades of tube which are designed to provide the spectrum of strength and stiffness required for safe design of scaffold systems. A colour coded system may thus be adopted to allow easy identification of the grade of tube. Without some clearly defined labelling system this variability of strength may pose considerable safety hazards for an operator uncertain as to whether a particular tube has strength adequate for the requirement of the job.

According to a third aspect of the present invention there is provided a structure comprising structural tubes according to the first aspect and/or a tube kit according to the second aspect.

Suitably, the structure comprises a scaffold structure. Suitably, the structure comprises a scaffold system.

### BRIEF DESCRIPTION OF DRAWINGS

The present invention will now be illustrated by way of example with reference to the accompanying drawings in which:

FIG. 1 shows a cross-section through a scaffold tube;

FIG. 2 shows a cross section through the tube wall;

FIG. 3 shows the orientation of fibres in layers 22 and 24;

FIG. 4 shows the orientation of fibres in layers 21, 23 and 25; and

FIG. 5 shows tubes assembled to form a tube and fitting scaffold system.

FIG. 6 shows a cross-section through the tube wall of an alternative embodiment of a scaffold tube.

### DETAILED DESCRIPTION OF PREFERRED EMBODIMENTS

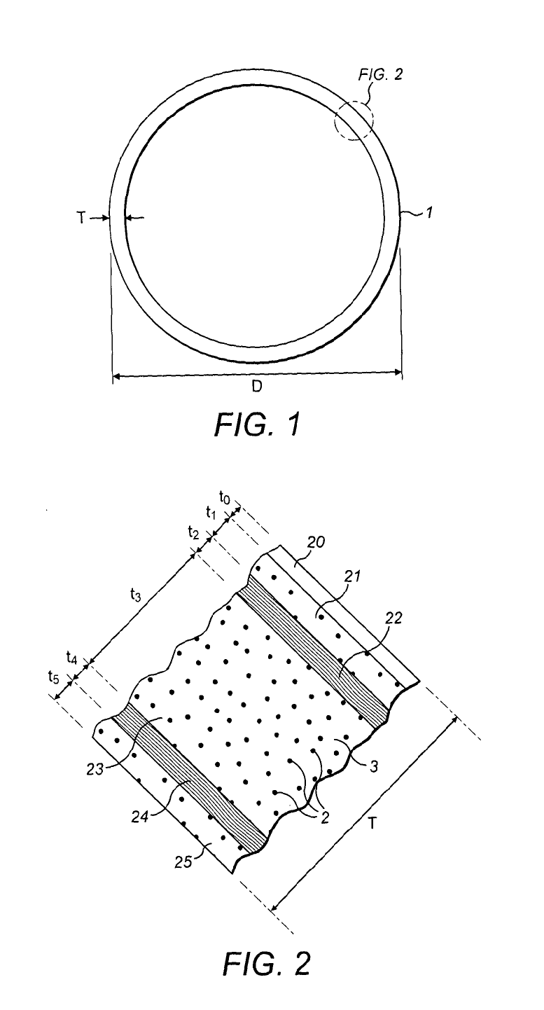

FIG. 1 is a cross-section through a structural tube 1. The tube is a hollow cylinder of circular cross section having an outer diameter D of 48.30 mm and a wall thickness T of 4.00 mm.

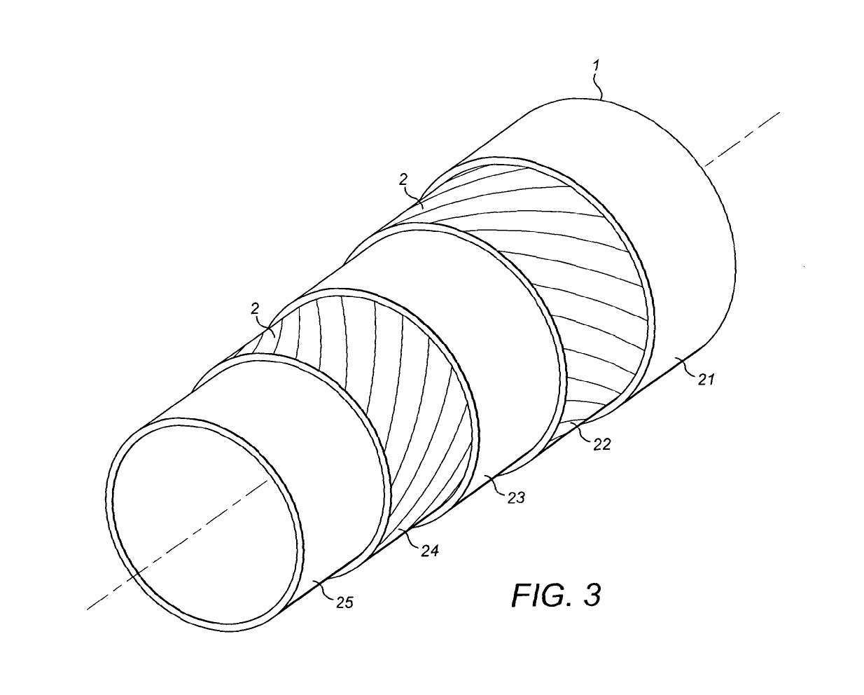

The tube 1 comprises multiple layers as best illustrated by FIG. 2. A polymeric resin 3 is used as the matrix binding together fibres of reinforcement 2, to provide an integral composite material for a circular cylindrical tube of total wall thickness, T. The polymeric resin 3 is a polyester. In an alternative vinylester may be used.

In the illustrated embodiment T is 4.00 mm but in other embodiments (not illustrated) different thicknesses, T, are used to provide the specific load carrying requirements for a scaffold system.

In the illustrated embodiment the fibres of reinforcement are e-glass fibres, e.g. alumino-borosilicate glass with 1% wt alkali-metal oxides. In other embodiments (not illustrated) the fibrous reinforcement can be formed from glass, aramid, boron, natural or carbon. In the illustrated embodiment the volume fraction of the fibre relative to the total material volume is 62% in layers 21, 23 and 25 having longitudinal fibres and 48% in layers 22 and 24 having helically wound fibres.

In other embodiments (not illustrated) different volume fractions of the fibre, relative to the total material volume, are chosen to provide adequate strength and stiffness for the specific load carrying requirements for the scaffold system.

Two layers of helically wound fibres, 22 and 24, having thickness t₂ and t₄ are separated by a distance t₃ to provide the required hoop stiffness and strength. Three layers of longitudinal fibres, 21, 23, 25, having thicknesses t₁, t₃, t₅, are chosen to provide an overall tube axial and bending stiffness adequate to achieve the structural strength and stiffness to allow use of the tube within a typical tube and fit scaffold structure. An external veil 20, thickness t₀ is provided to protect the reinforcement from surface wear and tear. Colour pigments added to the polymeric resin are used to provide a clear indication of the strength grade of the tube. The thicknesses are as follows:

t0=0.20 mm;
t1=0.49 mm;
t2=0.30 mm;
t3=2.34 mm;
t4=0.29 mm; and
t5=0.38 mm;

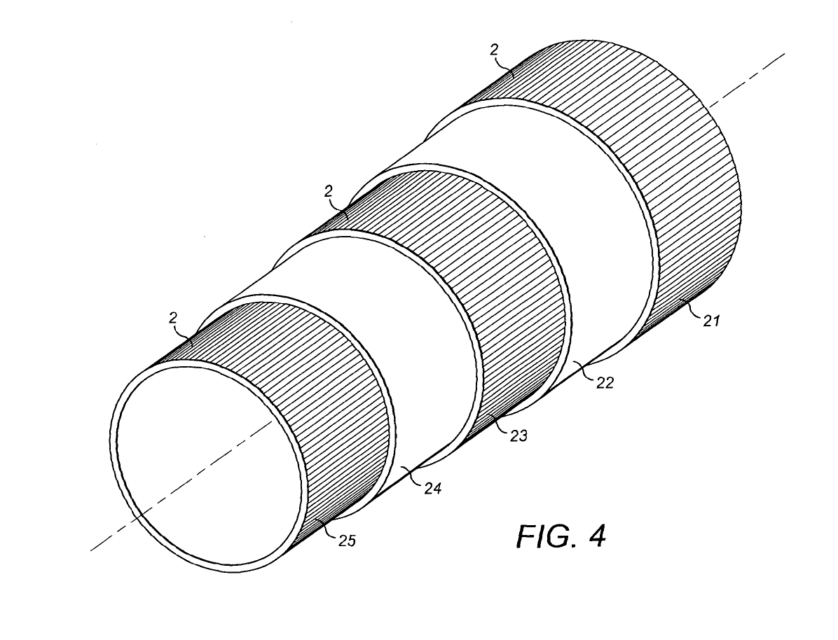

FIG. 3 illustrates the helical manner in which fibres 2 are wound in layers 22 and 24. The pitch of the helically wound fibres is 20 mm. FIG. 4 illustrates the longitudinal manner in which fibres 2 extend in layers 21, 23 and 25.

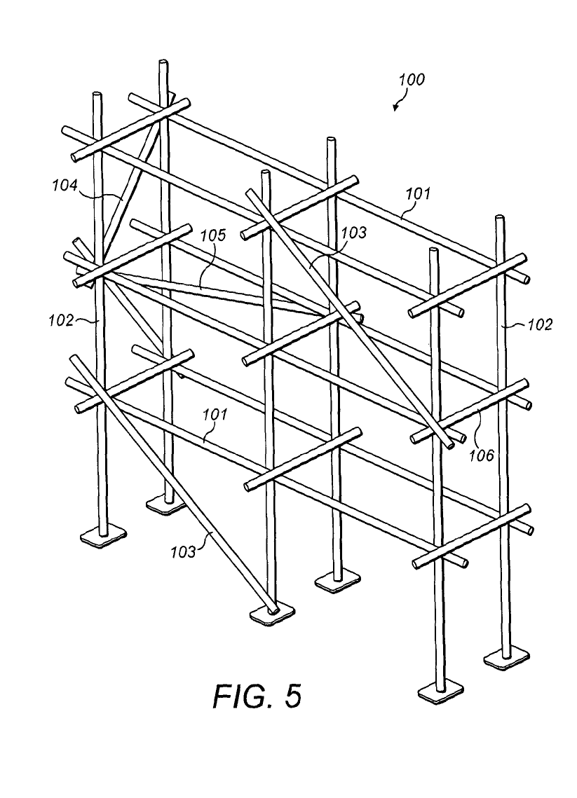

FIG. 5 illustrates a scaffold system 100 comprising tubes 1 of the invention. The system 100 comprises tubes of various strength grades. Continuous lengths of the particular strength grade of tube are manufactured to provide the strength and stiffness of tube needed for the specific load carrying requirements for the scaffold system. These continuous lengths are cut into whatever lengths are needed to provide the ledgers, 101, standards, 102, longitudinal braces, 103, lateral braces, 104, plan brace, 105, and transoms, 106, required to form a structurally sound fabricated tubular frame scaffold system.

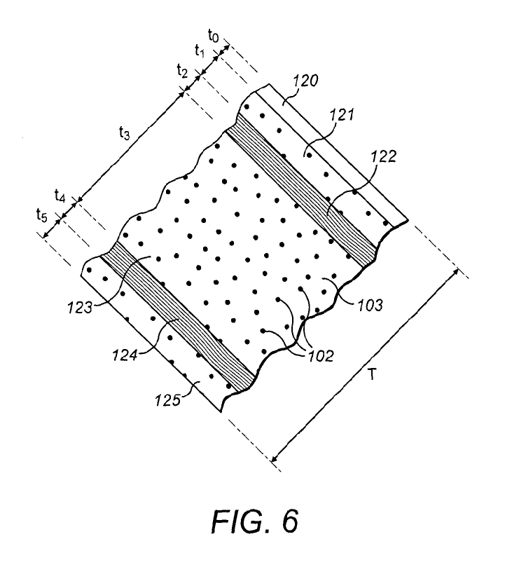

FIG. 6 illustrates a further embodiment of a structural tube. FIG. 6 is a cross-section through a structural tube 100 wall. The tube is a hollow cylinder of circular cross section having an outer diameter of 48.30 mm and a wall thickness T of 4.40 mm.

The tube 100 comprises multiple layers. A polymeric resin 103 is used as the matrix binding together fibres of reinforcement 102, to provide an integral composite material for a circular cylindrical tube of total wall thickness, T. The polymeric resin 103 is a polyester.

In the illustrated embodiment the fibres of reinforcement are e-glass fibres, alumino-borosilicate glass with 1% wt alkali-metal oxides. In the illustrated embodiment the volume fraction of the fibre relative to the total material volume is 56% in layers 121, 123 and 125 having longitudinal fibres and 56% in layers 122 and 124 having helically wound fibres.

Two layers of helically wound fibres, 122 and 124, having thickness t2 and t4 are separated by a distance t3 to provide the required hoop stiffness and strength. Three layers of longitudinal fibres, 121, 123, 125, having thicknesses t1, t3, t5, are chosen to provide an overall tube axial and bending stiffness adequate to achieve the structural strength and stiffness to allow use of the tube within a typical tube and fit scaffold structure. An external veil 120, thickness t0 is provided to protect the reinforcement from surface wear and tear. In further embodiments (not illustrated) colour pigments can be added to the polymeric resin to provide a clear indication of the ownership or use of the tube or for other purposes such as site safety, corporate awareness or public/pedestrian visibility. The thicknesses are as follows:

t0=0.2 mm;
t1=0.63 mm;
t2 0.20 mm;
t3=2.35 mm;
t4=0.20 mm; and
t5=0.82 mm;

The tube comprises the following layers:

(i) protective layer 120;
ii) longitudinally extending fibre layer 121;
(iii) helically wound fibre layer 122;
(iv) longitudinal extending fibre layer 123;
(v) helically wound fibre layer 124;
(vi) longitudinally extending fibre layer 125;

Layer 121 comprises 32 number of 4.8 g/m bundles of filament fibres having relative density of 2.55, in polyester matrix having relative density 1.2, giving layer thickness 0.63 mm and fibre volume fraction 56%.

Layer 123 comprises 100 number of 4.8 g/m bundles of filament fibres having relative density of 2.55, in polyester matrix having relative density 1.2, giving layer thickness 2.35 mm and fibre volume fraction 56%.

Layer 125 comprises 32 number of 4.8 g/m bundles of filament fibres having relative density of 2.55, in polyester matrix having relative density 1.2, giving layer thickness 0.20 mm and a fibre volume fraction 56%.

Layer 122 comprises a 1.2 q/m bundle of filament fibres with a pitch of 4 mm having relative density of 2.55, in polyester matrix having relative density 1.2, with each bundle being wound to have a helical pitch of 4 mm, giving layer thickness of 0.2 mm and fibre volume fraction 56%.

Layer 124 comprises a 1.2 g/m bundle of filament fibres with a pitch of 4 mm having relative density of 2.55, in polyester matrix having relative density 1.2, with each bundle wound to have a helical pitch of 4 mm, giving layer thickness of 0.20 mm and fibre volume fraction 56%.

Layers 122 and 124 each comprise a helically wound fibre bundle. The pitch of the helically wound fibre bundles is 4 mm. In layers 121, 123 and 125 fibres extend longitudinally.

It will be appreciated that preferred embodiments of the present invention may provide structural tubes with beneficial properties.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A structural tube comprising a fibre reinforced polymer wherein the tube comprises a plurality of layers of reinforcing fibres with the fibres of at least one layer having a different orientation to those of another layer.

2. A structural tube according to claim 1, wherein the tube comprises helically wound fibres, and longitudinally extending fibres, and is a scaffold tube.

3. (canceled)

4. (canceled)

5. (canceled)

6. (canceled)

7. (canceled)

8. (canceled)

9. (canceled)

10. (canceled)

11. A structural tube according to claim 1, wherein the tube comprises three or more layers of fibres.

12. (canceled)

13. (canceled)

14. (canceled)

15. (canceled)

16. A structural tube according to claim 1, wherein the tube comprises two or more layers of helically wound fibres and three or more layers of longitudinally extending fibres.

17. (canceled)

18. A structural tube according to claim 1, wherein the tube comprises two layers of helically wound fibres interposed by one or more layers of longitudinally extending fibres and/or one or more substantially fibre free layers of polymeric matrix.

19. A structural tube according to claim 1, wherein the tube is such that two layers of helically wound fibres are spaced apart by one or more layers of longitudinally extending fibres by a distance of at least 0.5 mm.

20. A structural tube according to claim 19, wherein the layer of longitudinal fibres spacing the helically wound fibres has a thickness of around 2.0 mm.

21. A structural tube according to claim 19, wherein the tube is such that a layer of longitudinal fibres located between two layers of helically wound fibres comprises a greater proportion (by volume) of longitudinal fibres than any other layer.

22. A structural tube according to claim 1, wherein the tube comprises two layers of longitudinally extending fibres interposed by one or more layers of helically wound fibres and/or one or more layers of longitudinally extending fibres and/or one or more substantially fibre free layers of polymeric matrix.

23. A structural tube according to claim 1, wherein the tube comprises two layers of longitudinally extending fibres interposed by two layers of helically wound fibres which in turn are interposed by a layer of longitudinally extending fibres.

24. A structural tube according to claim 1, wherein the tube comprises an external protective layer.

25. (canceled)

26. A structural tube according to claim 1, wherein the tube comprises concentric layers with the following composition from outermost to innermost layer:
(i) protective layer
(ii) longitudinally extending fibre layer;
(iii) helically wound fibre layer;
(iv) longitudinal extending fibre layer;
(v) helically wound fibre layer;
(vi) longitudinally extending fibre layer.

27. (canceled)

28. A structural tube according to claim 1, wherein the tube comprises two layers of helically wound fibres having respective thicknesses t2 and t4 and which are interposed by a layer of longitudinal extending fibres having thickness t3, wherein t3 is greater than t2 and t3 is greater than t4, and wherein t2 is no more than twice the size of t4 and no less than half the size of t4.

29. (canceled)

30. (canceled)

31. (canceled)

32. (canceled)

33. (canceled)

34. A structural tube according to claim 1, wherein the tube comprises layers having the following composition:
(i) protective layer, thickness t0 about 0.20 mm;
(ii) longitudinally extending fibre layer thickness t1 about 0.49 mm;
(iii) helically wound fibre layer thickness t2 about 0.30 mm;
(iv) longitudinal extending fibre layer thickness t3 about 2.34 mm;
(v) helically wound fibre layer thickness t4 about 0.29 mm;
(vi) longitudinally extending fibre layer thickness t5 about 0.38 mm;

35. A structural tube according to claim 1, wherein the tube comprises layers having the following composition:
(i) protective layer, thickness t0 about 0.20 mm;
(ii) longitudinally extending fibre layer thickness t1 about 0.63 mm;
(iii) helically wound fibre layer thickness t2 about 0.2 mm;
(iv) longitudinal extending fibre layer thickness t3 about 2.35 mm;
(v) helically wound fibre layer thickness t4 about 0.2 mm;
(vi) longitudinally extending fibre layer thickness t5 about 0.82 mm;

36. A structural tube according to claim 1, wherein the tube comprises longitudinal extending fibres provided in fibre bundles of fibre filaments, and wherein the longitudinal fibre bundles are between 1 g/m and 10 g/m, and wherein each layer of longitudinal extending fibres comprises fibres such that they have a volume fraction of from 50% to 80%.

37. (canceled)

38. (canceled)

39. A structural tube according to claim 1, wherein the tube comprises helically wound fibres provided in fibre bundles of fibre filaments and wherein the helically wound fibre bundles are between 0.5 g/m and 10 g/m and wherein each layer of helically wound fibres comprises fibres such that they have a volume fraction of from 40% to 70%.

40. (canceled)

41. (canceled)

42. A structural tube according to claim 1, wherein the pitch of the helically wound fibres is from 1 mm to 10 mm.

43. (canceled)

44. (canceled)

45. A structural tube according to claim 1, wherein the tube is translucent and is adapted such that a light source can be located within the cavity defined by the tube wall and transmit light to the exterior of the tube.

46. (canceled)

47. (canceled)

48. (canceled)

49. A kit of structural tubes wherein the kit comprises a plurality of tubes according to claim 1 and wherein at least one tube has a first strength grade and is provided with strength indicator means and at least one tube has a second strength grade and is provided with strength indicator means such that tubes of different strength grades can be readily distinguished.

50. (canceled)

51. A structure comprising structural tubes according to claim 1.

52. (canceled)

53. (canceled)
